(19) United States
(12) Patent Application Publication
(10) Pub. No.: US 2015/0123871 A1
(43) Pub. Date: May 7, 2015

(54) MOBILE DEVICE AND ANTENNA STRUCTURE WITH CONDUCTIVE FRAME

(71) Applicant: Acer Incorporated, New Taipei City (TW)

(72) Inventors: Chih-Hua Chang, New Taipei City (TW); Shao-Yu Huang, New Taipei City (TW); Hsien-Chang Lin, New Taipei City (TW)

(73) Assignee: Acer Incorporated, New Taipei City (TW)

(21) Appl. No.: 14/073,097

(22) Filed: Nov. 6, 2013

(51) Int. Cl. H01Q 1/24

(52) U.S. Cl. CPC H01Q 1/243
USPC 343/872; 343/700 MS

(57) ABSTRACT

A mobile device includes a dielectric substrate, a ground element, a signal source, a first conductive frame, a second conductive frame, a third conductive frame, a shorting element, a feeding element, a first radiation element, and a second radiation element. The first conductive frame, the second conductive frame, and the third conductive frame are separate from each other. The second conductive frame is coupled through the shorting element to the ground element. The first radiation element is coupled to the feeding element. An open end of the first radiation element is adjacent to the second conductive frame. The second radiation element is coupled to the feeding element. An open end of the second radiation element is adjacent to the third conductive frame. An antenna structure is formed by the feeding element, the first radiation element, the second radiation element, the shorting element, and the second conductive frame.

### CROSS REFERENCE TO RELATED APPLICATIONS

This Application claims priority of Taiwan Patent Application No. 102128046 filed on Aug. 6, 2013, the entirety of which is incorporated by reference herein.

### BACKGROUND OF THE INVENTION

1. Field of the Invention

The disclosure generally relates to a mobile device, and more particularly, to a mobile device with an antenna structure formed by conductive frames.

2. Description of the Related Art

With the progress of mobile communication technology, portable electronic devices, for example, portable computers, mobile phones, tablet computers, multimedia players, and other hybrid functional mobile devices, have become more common To satisfy user demand, portable electronic devices can usually perform wireless communication functions. Some functions cover a large wireless communication area, for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area, for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

To provide a beautiful appearance, the design of a mobile device may comprise some exterior metal elements, such as a metal back cover or a metal frame. However, these exterior metal elements often negatively affect the antenna structure in the mobile device for wireless communication, thereby reducing the communication quality of the mobile device.

### BRIEF SUMMARY OF THE INVENTION

To solve the aforementioned problems, in one exemplary embodiment, the disclosure is directed to a mobile device, comprising: a dielectric substrate; a ground element, disposed on the dielectric substrate; a signal source; a first conductive frame; a second conductive frame; a third conductive frame, wherein the first conductive frame, the second conductive frame, and the third conductive frame are separate from each other; a first shorting element, wherein the second conductive frame is coupled through the first shorting element to the ground element; a feeding element, coupled to the signal source; a first radiation element, coupled to the feeding element, and having an open end, wherein the open end of the first radiation element is adjacent to the second conductive frame; and a second radiation element, coupled to the feeding element, and having an open end, wherein the open end of the second radiation element is adjacent to the third conductive frame, wherein an antenna structure is at least formed by the feeding element, the first radiation element, the second radiation element, the second conductive frame, and the first shorting element.

### BRIEF DESCRIPTION OF DRAWINGS

The invention can be more fully understood by reading the subsequent detailed description and examples with references made to the accompanying drawings, wherein:

FIG. 1A is a perspective view for illustrating a mobile device according to an embodiment of the invention;

FIG. 1B is a top view for illustrating a mobile device according to an embodiment of the invention;

FIG. 2 is a diagram for illustrating return loss of an antenna structure of a mobile device according to an embodiment of the invention;

FIG. 3 is a diagram for illustrating antenna efficiency of an antenna structure of a mobile device according to an embodiment of the invention;

FIG. 4 is a perspective view for illustrating a mobile device according to an embodiment of the invention; and

FIG. 5 is a perspective view for illustrating a mobile device according to an embodiment of the invention.

### DETAILED DESCRIPTION OF THE INVENTION

In order to illustrate the purposes, features and advantages of the invention, the embodiments and figures thereof in the invention are shown in detail as follows.

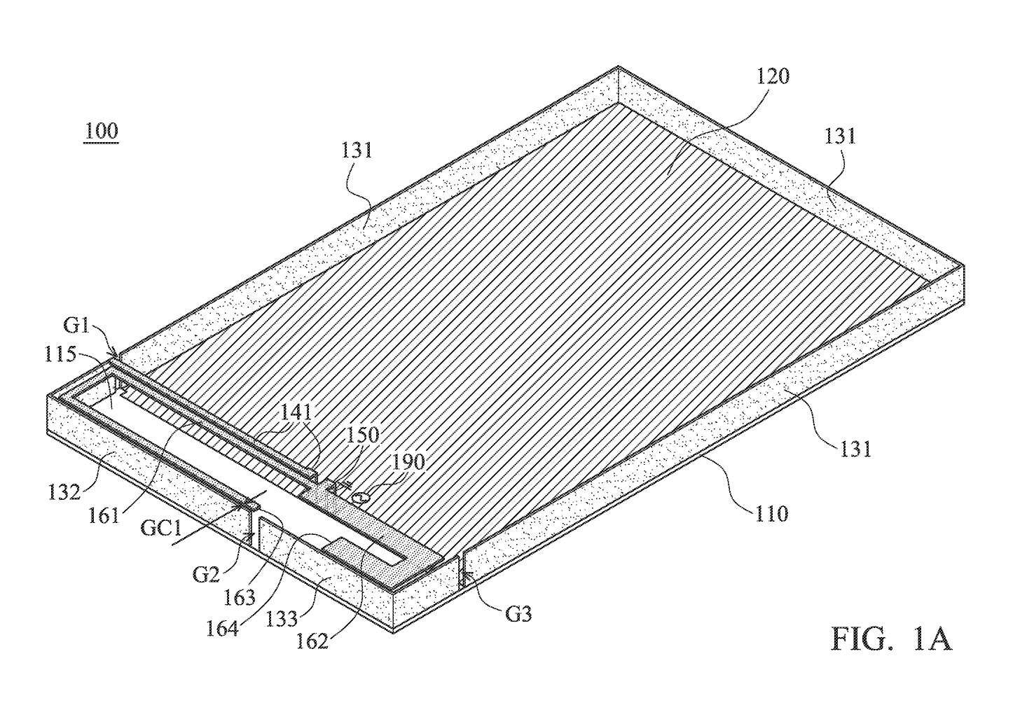

FIG. 1A is a perspective view for illustrating a mobile device 100 according to an embodiment of the invention. FIG. 1B is a top view for illustrating the mobile device 100 according to an embodiment of the invention. Please refer to FIG. 1A and FIG. 1B together. The mobile device 100 may be a smart phone or a tablet computer. As shown in FIG. 1A and FIG. 1B, the mobile device 100 at least comprises a dielectric substrate 110, a ground element 120, a first conductive frame 131, a second conductive frame 132, a third conductive frame 133, a first shorting element 141, a feeding element 150, a first radiation element 161, a second radiation element 162, and a signal source 190. The dielectric substrate 110 may be a system circuit board or an FR4 (Flame Retardant 4) substrate. The ground element 120 may be a ground plane disposed on the dielectric substrate 110. In some embodiments, the ground element 120, the first conductive frame 131, the second conductive frame 132, the third conductive frame 133, the first shorting element 141, the feeding element 150, the first radiation element 161, and the second radiation element 162 are all made of metal, such as silver, copper, aluminum, or iron. Note that the mobile device 100 may further comprise other components, such as a processor, a touch-control panel, a touch-control module, a speaker, a battery module, and a housing (not shown).

The first conductive frame 131, the second conductive frame 132, and the third conductive frame 133 are separate from each other. As shown in FIG. 1A and FIG. 1B, a first gap G1 is formed between the first conductive frame 131 and the second conductive frame 132, a second gap G2 is formed between the second conductive frame 132 and the third conductive frame 133, and a third gap G3 is formed between the first conductive frame 131 and the third conductive frame 133. In some embodiments, the mobile device 100 further comprises a nonconductive housing (not shown). The nonconductive housing may be made of a plastic material. The first conductive frame 131, the second conductive frame 132, and the third conductive frame 133 may be disposed on an exterior surface of the nonconductive housing. The other components (e.g., the dielectric substrate 110, and the ground element 120, . . . etc.) of the mobile device 100 may be disposed in the nonconductive housing. The first conductive frame 131 may be coupled to or decoupled from the ground element 120. The second conductive frame 132 is coupled through the first shorting element 141 to the ground element 120. In some embodiments, a portion of the first shorting element 141 is implemented with a pogo pin or a metal spring. The third conductive frame 133 may be floating and not coupled to the ground element 120. In some embodiments, the length of the first conductive frame 131 is much greater than the length of the second conductive frame 132, and is much greater than the length of the third conductive frame 133. In some embodiments, the length of the second conductive frame 132 is greater than the length of the third conductive frame 133. More particularly, the first conductive frame 131 may substantially have a U-shape, the second conductive frame 132 may substantially have an L-shape, and the third conductive frame 133 may also substantially have an L-shape. Note that the shapes of the first conductive frame 131, the second conductive frame 132, and the third conductive frame 133 are not limited in the invention. In other embodiments, any of the first conductive frame 131, the second conductive frame 132, and the third conductive frame 133 may substantially have a straight-line shape or a J-shape, to be consistent with the shape of the edge of the nonconductive housing.

In the mobile device 100, an antenna structure is at least formed by the feeding element 150, the first radiation element 161, the second radiation element 162, the second conductive frame 132, and the first shorting element 141. The detailed composition of the antenna structure is described in the following embodiments.

The feeding element 150 is coupled to the signal source 190. The feeding element 150 may be substantially perpendicular to the first radiation element 161, the second radiation element 162, and the dielectric substrate 110. In some embodiments, the feeding element 150 is implemented with a pogo pin or a metal spring. A feeding end of the first radiation element 161 is coupled to the feeding element 150, and an open end 163 of the first radiation element 161 is adjacent to the second conductive frame 132. The first radiation element 161 may substantially extend along the first shorting element 141 and the second conductive frame 132, and may be adjacent to the first shorting element 141 and the second conductive frame 132. In some embodiments, a first coupling gap GC1 is formed between the open end 163 of the first radiation element 161 and the second conductive frame 132, wherein the width of the first coupling gap GC1 is preferably smaller than 1 mm. The length of the first radiation element 161 may be substantially equal to the total length of the first shorting element 141 and the second conductive frame 132. The length of the first radiation element 161 may be greater than the length of the second radiation element 162, and the width of the first radiation element 161 may be smaller than the width of the second radiation element 162. A feeding end of the second radiation element 162 is coupled to the feeding element 150, and an open end 164 of the second radiation element 162 is adjacent to the third conductive frame 133. At least a portion of the second radiation element 162 may substantially extend along the third conductive frame 133. Note that the first radiation element 161 is separate from the second conductive frame 132 and the first shorting element 141, and the second radiation element 162 is separate from the third conductive frame 133, wherein the feeding energy from the signal source 190 is transmitted between the above elements by mutual coupling.

In some embodiments, the first radiation element 161 and the second radiation element 162 are located on a plane (e.g., a virtual plane, a nonconductive planar supporting element, or a flexible printed circuit board), and the plane is separate from the dielectric substrate 110 and is substantially parallel to the dielectric substrate 110. The dielectric substrate 110 may further have a non-grounding region 115. The non-grounding region 115 may be adjacent to an edge of the dielectric substrate 110, and may substantially have a rectangular shape. In some embodiments, the first radiation element 161 has a first projection on the dielectric substrate 110, the second radiation element 162 has a second projection on the dielectric substrate 110, and the first shorting element 141 has a third projection on the dielectric substrate 110, wherein the first projection, the second projection, and the third projection are all within the non-grounding region 115. More particularly, the first radiation element 161 may substantially have a U-shape, and the second radiation element 162 may substantially have a J-shape. Note that the shapes of the first radiation element 161 and the second radiation element 162 are not limited in the invention. In other embodiments, any of the first radiation element 161 and the second radiation element 162 may substantially have a straight-line shape or an L-shape, to be consistent with the shape of the second conductive frame 132 or the third conductive frame 133.

In some embodiments, the element sizes of the mobile device 100 may be as follows. The ground element 120 has a length of about 110 mm and a width of about 65 mm. The non-grounding region 115 has a length of about 12 mm and a width of about 65 mm. The first conductive frame 131 has a length of about 281 mm and a height of about 5 mm. The second conductive frame 132 has a length of about 50 mm and a height of about 5 mm. The third conductive frame 133 has a length of about 37 mm and a height of about 5 mm. The first gap G1 has a width of about 2 mm. The second gap G2 has a width of about 2 mm. The third gap G3 has a width of about 2 mm. The first shorting element 141 has a length of about 43 mm and a width of about 1 mm. The first radiation element 161 has a length of about 86 mm and a width of about 1 mm. The second radiation element 162 has a length of about 35 mm and a width of about 3.5 mm. The first coupling gap GC1 has a width of about 0.5 mm. The antenna structure has a total height of about 5 mm on the dielectric substrate 110.

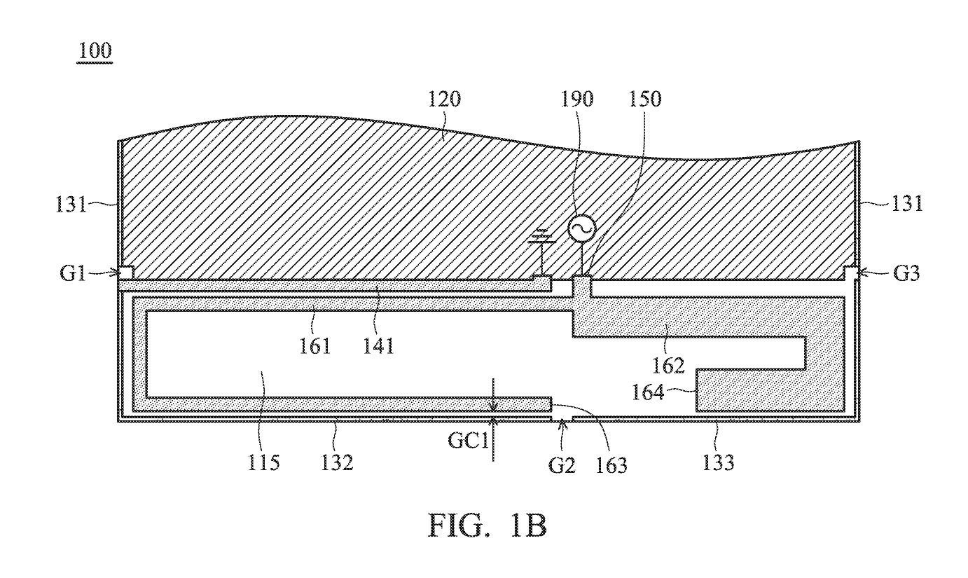

FIG. 2 is a diagram for illustrating return loss of the antenna structure of the mobile device 100 according to an embodiment of the invention. The horizontal axis represents operation frequency (MHz), and the vertical axis represents the return loss (dB). As shown in FIG. 2, the antenna structure of the mobile device 100 is excited to generate at least a first band FB1 and a second band FB2. As to the antenna theory, the first radiation element 161 is excited to generate a first resonant mode (fundamental resonant mode) and a second resonant mode (higher-order resonant mode), the second radiation element 162 is excited to generate a third resonant mode, and the second conductive frame 132 and the first shorting element 141 are excited to generate a fourth resonant mode. The lower first band FB1 is formed by the first resonant mode and the fourth resonant mode. The higher second band FB2 is formed by the second resonant mode and the third resonant mode. In a preferred embodiment, the first band FB1 is substantially from 700 MHz to 960 MHz, and the second band FB2 is substantially from 1710 MHz to 1990 MHz. Accordingly, the antenna structure of the mobile device 100 can at least cover the LTE (Long Term Evolution) 700/800/1800 bands and the GSM (Global System for Mobile Communications) 850/900/1800/1900 bands, such that the multi-band operation of LTE/WWAN (Long Term Evolution /Wireless Wide Area Network) can be achieved.

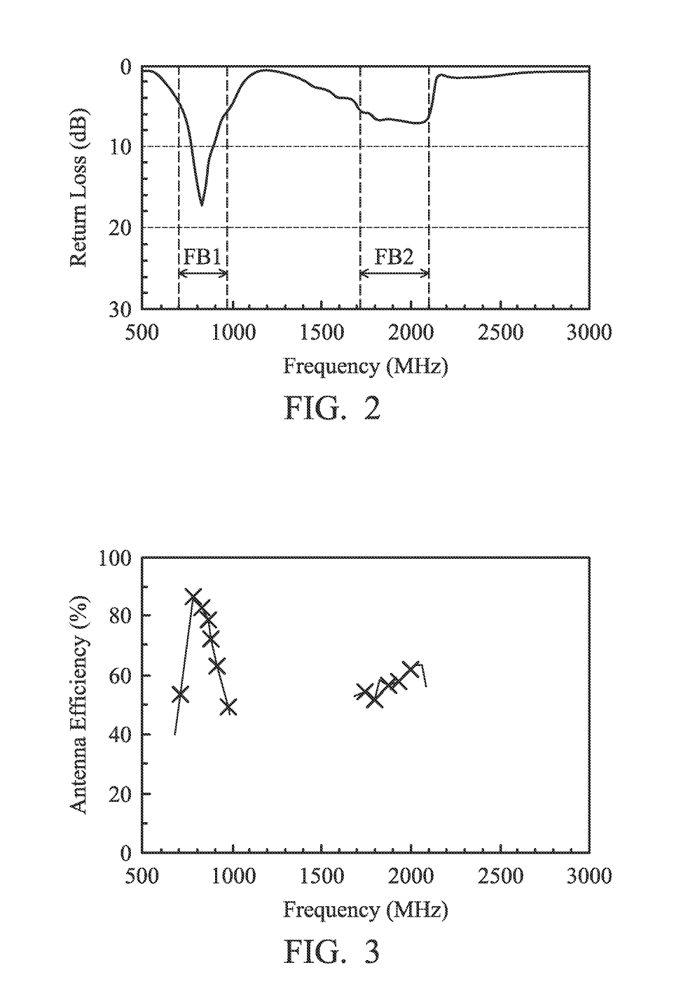

FIG. 3 is a diagram for illustrating antenna efficiency of the antenna structure of the mobile device 100 according to an embodiment of the invention. The horizontal axis represents operation frequency (MHz), and the vertical axis represents the antenna efficiency (%). As shown in FIG. 3, the antenna structure of the mobile device 100 has the antenna efficiency which is substantially from 43% to 83% in the first band FB1 and is substantially from 51% to 62% in the second band FB2. The antenna efficiency can meet the requirements of practical applications.

The mobile device of the invention comprises an antenna structure formed by a plurality of separate conductive frames and a plurality of monopole radiation elements. Since the conductive frames are considered as a portion of the antenna structure, they will not negatively affect the radiation performance of the antenna structure. On the contrary, the conductive frames can provide additional resonant paths for the antenna structure, such that the antenna structure can cover a wide band without occupying more inner space of the mobile device. The invention has the advantages of improving the appearance and maintaining the antenna radiation efficiency of a variety of small-size mobile communication devices.

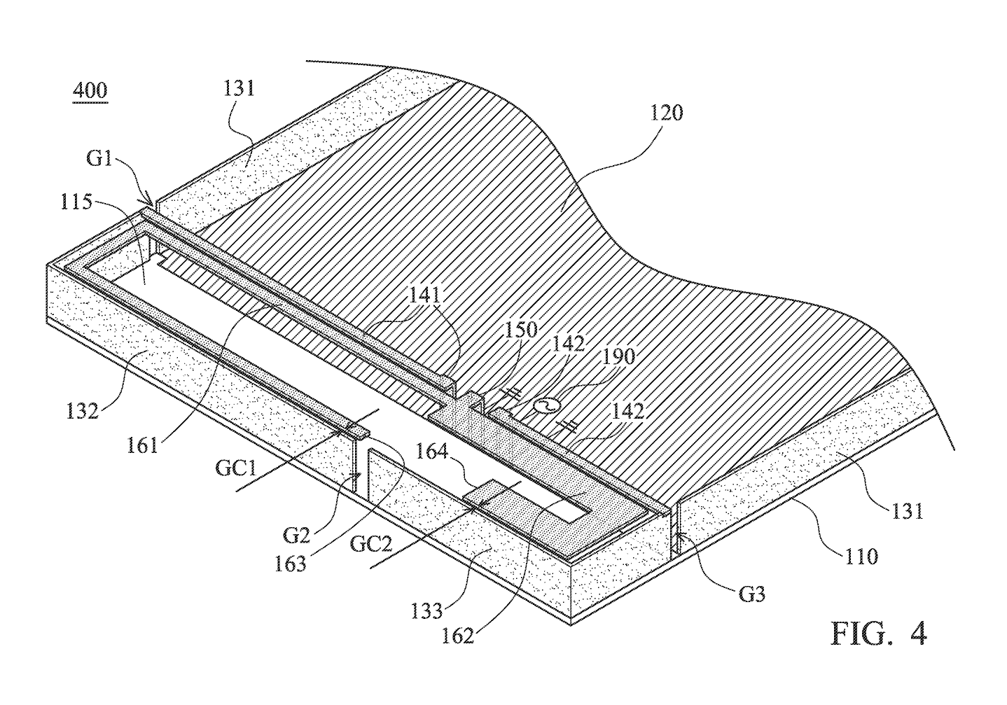

FIG. 4 is a perspective view for illustrating a mobile device 400 according to an embodiment of the invention. FIG. 4 is similar to FIG. 1. In the embodiment of FIG. 4, the mobile device 400 further comprises a second shorting element 142, and an antenna structure of the mobile device 400 further comprises the third conductive frame 133 and the second shorting element 142. The second shorting element 142 is made of metal, such as silver, copper, aluminum, or iron. In some embodiments, a portion of the second shorting element 142 is implemented with a pogo pin or a metal spring. The third conductive frame 133 is further coupled through the second shorting element 142 to the ground element 120. A second coupling gap GC2 is further formed between the open end 164 of the second radiation element 162 and the third conductive frame 133, wherein the width of the second coupling gap GC2 is preferably smaller than 1 mm. The third conductive frame 133 and the second shorting element 142 are excited to generate a fifth resonant mode, such that the antenna structure of the mobile device 400 can further cover the WCDMA (Wideband Code Division Multiple Access) Band 1. Other features of the mobile device 400 of FIG. 4 are similar to those of the mobile device 100 of FIG. 1. Accordingly, the two embodiments can achieve similar performances.

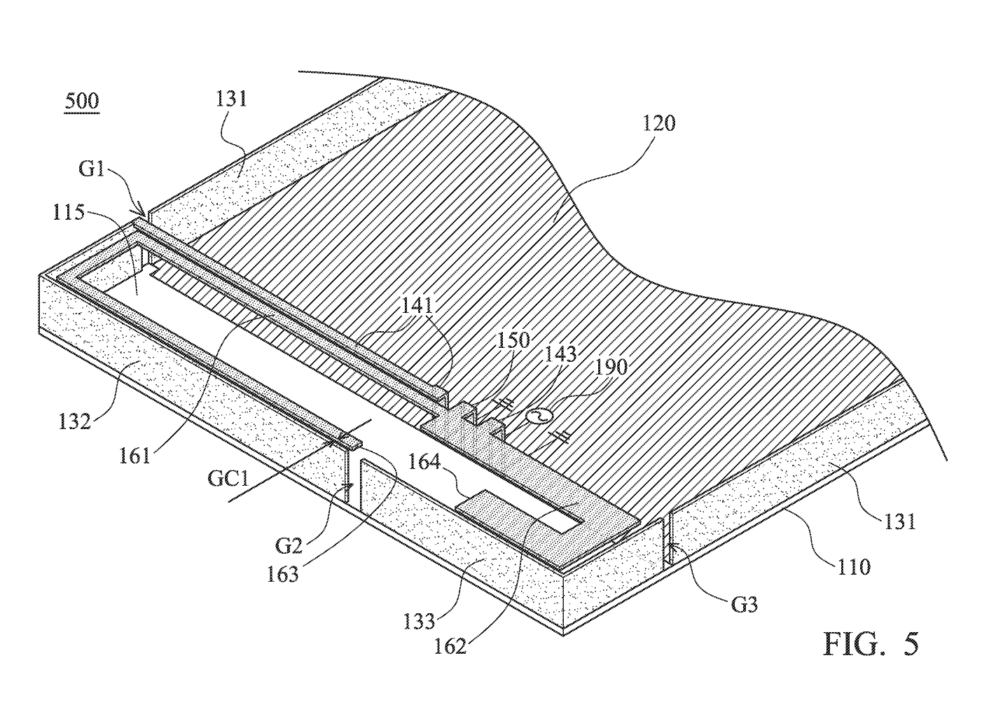

FIG. 5 is a perspective view for illustrating a mobile device 500 according to an embodiment of the invention. FIG. 5 is similar to FIG. 1. In the embodiment of FIG. 5, the mobile device 500 further comprises a third shorting element 143. The third shorting element 143 is made of metal, such as silver, copper, aluminum, or iron. In some embodiments, the third shorting element 143 is implemented with a pogo pin or a metal spring. The second radiation element 162 is further coupled through the third shorting element 143 to the ground element 120. The third shorting element 143 is adjacent to and parallel to the feeding element 150. An approximate PIFA (Planar Inverted F Antenna) may be formed by the feeding element 150, the third shorting element 143, and the second radiation element 162 of the mobile device 500, wherein the PIFA has better impedance matching than other types of antennas. Other features of the mobile device 500 of FIG. 5 are similar to those of the mobile device 100 of FIG. 1. Accordingly, the two embodiments can achieve similar performances.

Note that the aforementioned element sizes, element parameters, element shapes, and frequency ranges are not limitations of the invention. An antenna engineer can adjust settings according to different requirements. In addition, the mobile device and the antenna structure of the invention are not limited to the configurations of FIGS. 1-5. The invention may merely include any one or more features of any one or more embodiments of FIGS. 1-5. In other words, not all of the features shown in the figures must be implemented in the mobile device and the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A mobile device, comprising:
a dielectric substrate;
a ground element, disposed on the dielectric substrate;
a signal source;
a first conductive frame;
a second conductive frame;
a third conductive frame, wherein the first conductive frame, the second conductive frame, and the third conductive frame are separate from each other;
a first shorting element, wherein the second conductive frame is coupled through the first shorting element to the ground element;
a feeding element, coupled to the signal source;
a first radiation element, coupled to the feeding element, and having an open end, wherein the open end of the first radiation element is adjacent to the second conductive frame; and
a second radiation element, coupled to the feeding element, and having an open end, wherein the open end of the second radiation element is adjacent to the third conductive frame,
wherein an antenna structure is at least formed by the feeding element, the first radiation element, the second radiation element, the second conductive frame, and the first shorting element.

2. The mobile device as claimed in claim 1, further comprising:
a nonconductive housing, wherein the first conductive frame, the second conductive frame, and the third conductive frame are all disposed on the nonconductive housing.

3. The mobile device as claimed in claim 1, wherein the first conductive frame is coupled to the ground element.

4. The mobile device as claimed in claim 1, wherein the third conductive frame is floating and not coupled to the ground element.

5. The mobile device as claimed in claim 1, wherein a first gap is formed between the first conductive frame and the second conductive frame, a second gap is formed between the second conductive frame and the third conductive frame, and a third gap is formed between the first conductive frame and the third conductive frame.

6. The mobile device as claimed in claim 1, wherein a length of the first conductive frame is greater than a length of the second conductive frame, and is greater than a length of the third conductive frame.

7. The mobile device as claimed in claim 1, wherein a length of the first radiation element is substantially equal to a total length of the first shorting element and the second conductive frame.

8. The mobile device as claimed in claim 1, wherein the first conductive frame substantially has a U-shape.

9. The mobile device as claimed in claim 1, wherein the second conductive frame substantially has an L-shape.

10. The mobile device as claimed in claim 1, wherein the third conductive frame substantially has an L-shape.

11. The mobile device as claimed in claim 1, wherein the first radiation element and the second radiation element are located on a plane, and wherein the plane is separate from the dielectric substrate and is substantially parallel to the dielectric substrate.

12. The mobile device as claimed in claim 11, wherein the feeding element is substantially perpendicular to the first radiation element, the second radiation element,

13. The mobile device as claimed in claim 11, wherein the dielectric substrate further has a non-grounding region, the first radiation element has a first projection on the dielectric substrate, the second radiation element has a second projection on the dielectric substrate, and the first shorting element has a third projection on the dielectric substrate, and wherein the first projection, the second projection, and the third projection are all within the non-grounding region.

14. The mobile device as claimed in claim 1, wherein the first radiation element substantially extends along the first shorting element and the second conductive frame, and is adjacent to the first shorting element and the second conductive frame.

15. The mobile device as claimed in claim 1, wherein a first coupling gap is formed between the open end of the first radiation element and the second conductive frame, and a width of the first coupling gap is smaller than 1 mm.

16. The mobile device as claimed in claim 1, wherein a length of the first radiation element is greater than a length of the second radiation element.

17. The mobile device as claimed in claim 1, wherein a width of the first radiation element is smaller than a width of the second radiation element.

18. The mobile device as claimed in claim 1, wherein the first radiation element substantially has a U-shape.

19. The mobile device as claimed in claim 1, wherein the second radiation element substantially has a J-shape.

20. The mobile device as claimed in claim 1, wherein the antenna structure is excited to generate a first band and a second band, the first band is substantially from 700 MHz to 960 MHz, and the second band is substantially from 1710 MHz to 1990 MHz.

21. The mobile device as claimed in claim 1, further comprising:
a second shorting element, wherein the third conductive frame is further coupled through the second shorting element to the ground element, and wherein the antenna structure further comprises the third conductive frame and the second shorting element.

22. The mobile device as claimed in claim 21, wherein a second coupling gap is further formed between the open end of the second radiation element and the third conductive frame, and a width of the second coupling gap is smaller than 1 mm.

23. The mobile device as claimed in claim 1, further comprising:
a third shorting element, wherein the second radiation element is further coupled through the third shorting element to the ground element, and the third shorting element is adjacent to and parallel to the feeding element.
